(19) United States
(12) Patent Application Publication
(10) Pub. No.: US 2025/0330779 A1
(43) Pub. Date: Oct. 23, 2025

(54) INFORMATION INTERACTION METHOD AND APPARATUS

(71) Applicant: FUJITSU LIMITED, Kawasaki-shi (JP)

(72) Inventors: Yujia SHAN, Beijing (CN); Xin WANG, Beijing (CN)

(73) Assignee: FUJITSU LIMITED, Kawasaki-shi (JP)

(21) Appl. No.: 19/256,436

(22) Filed: Jul. 1, 2025

Related U.S. Application Data
(63) Continuation of application No. PCT/CN2023/071726, filed on Jan. 10, 2023.

(51) Int. Cl. H04W 4/029

(52) U.S. Cl. CPC H04W 4/029

(57) ABSTRACT

An information interaction apparatus, configured in a first device, includes: a transmitter configured to transmit to a second device a model-related information request and/or an entity-related information request for optimizing a wireless positioning AI/ML model; and a receiver configured to receive model-related information feedback and/or entity-related information feedback transmitted by the second device.

### CROSS-REFERENCE TO RELATED APPLICATION

This application is a continuation application under 35 U.S.C. 111 (a) of International Patent Application PCT/CN2023/071726 filed on Jan. 10, 2023, and designated the U.S., the entire contents of which are incorporated herein by reference.

### TECHNICAL FIELD

The present application relates to the field of communication technologies.

### BACKGROUND

With the commercialization of the fifth generation (5G) communication, especially the large-scale expansion of the industrial Internet industry, the demand of positioning terminal equipment in wireless communication has increased significantly. Traditional wireless positioning is based on multiple technologies, among which the one directly related to 5G NR (New Radio) is mainly a positioning method that performs estimation by utilizing a channel measurement result between a network entity and a terminal, such as TDOA (Time Difference of Arrival), E-CID (Enhanced Cell ID), and Multi-RTT (Multi-Round-Trip Time) etc. These traditional positioning methods all have several inherent defects, resulting in poor positioning accuracy of terminal equipment in different wireless environments or scenarios, especially in wireless environments with severe Non-Light of Sight (NLOS), such as InF (Indoor Factory) and the like. The error values of traditional positioning methods are very large, which are usually difficult to accept.

The fundamental reason is that the positioning method based on wireless channel measurement is effective only in light of sight (LOS) environments, and the wireless channel measurement value obtained in non-light of sight environments has a significant deviation from an ideal value, and the accuracy of result of terminal positioning directly depends on this measurement value, thus the measurement error leads to the generation of errors in the final terminal positioning results.

In recent years, artificial intelligence machine learning (AI/ML) technology represented by deep learning has developed rapidly and has been applied in multiple research and commercial fields due to its powerful nonlinear fitting ability. Similarly, the evaluation performance of artificial intelligence application in wireless positioning has also been significantly improved compared with traditional methods.

However, due to the complexity and variability of wireless communication environments and the inherent characteristics of AI/ML models based on big data used for wireless positioning, the performance of generalization (consistency in inference operations using the same model in different environments) of the AI/ML models is poor. When the performance of the AI/ML models cannot achieve high positioning accuracy in the current wireless environment or is insufficient to meet the accuracy requirement of the current wireless application for the terminal, one of the solutions is to perform different types of customized training for the AI/ML models, including retraining, fine-tuning training, or partial update training of the models.

When traditional methods are used for positioning, regardless of their performance, the mathematical model and calculation process corresponding to the method itself are fixed, and it is impossible to improve the positioning accuracy through real-time algorithm improvement of the method. The AI/ML models are data-driven, and as long as different training datasets may be input to the models or model training related parameters may be adjusted, the positioning accuracy may be improved to a certain extent in a targeted manner.

It should be noted that, the above introduction to the background is merely for the convenience of clear and complete description of the technical solution of the present application, and for the convenience of understanding of persons skilled in the art. It cannot be regarded that the above technical solution is commonly known to persons skilled in the art just because that the solution has been set forth in the background of the present application.

### SUMMARY

However, the inventor finds that the wireless positioning process defined in the current 3GPP protocol does not involve the relevant concepts of the AI/ML models. The customization of the training process needs to follow the life cycle management process of the AI/ML models, and duration, resource usage, and parameter configuration etc. of AI/ML model training are directly related to the training accuracy. The positioning accuracy requirements and available resources in various scenarios are not fixed, but dynamically adjusted along with environmental changes. Therefore, the network entities involved in positioning need to engage in a series of information interaction to select the optimal solution for model training in terms of positioning accuracy, positioning delay, resource usage, and transmission overhead. However, this series of information interaction is not clearly defined in the current protocol.

To address at least one of the above problems, embodiments of the present application provide an information interaction method and an apparatus, in which information interaction may be performed between network entities participating in positioning and between network entities and terminals, thereby achieving customized training for optimizing wireless positioning AI/ML models and obtaining more accurate positioning results.

According to an aspect of the embodiments of the present application, there is provided with an information interaction method, including:
a first device transmitting a model-related information request and/or an entity-related information request for optimizing a wireless positioning AI/ML model to a second device; and
the first device receiving model-related information feedback and/or entity-related information feedback transmitted by the second device.

According to another aspect of the embodiments of the present application, there is provided with an information interaction apparatus, configured in a first device, the information interaction apparatus including:
a transmitting unit configured to transmit a model-related information request and/or an entity-related information request for optimizing a wireless positioning AI/ML model to a second device; and
a receiving unit configured to receive model-related information feedback and/or entity-related information feedback transmitted by the second device.

According to another aspect of the embodiments of the present application, there is provided with an information interaction method, including:
a second device receiving model-related information request and/or entity-related information request from a first device for optimizing a wireless positioning AI/ML model; and
the second device transmitting model-related information feedback and/or entity-related information feedback to the first device.

According to another aspect of the embodiments of the present application, there is provided with an information interaction apparatus, configured in a second device, the information interaction apparatus including:
a receiving unit configured to receive model-related information request and/or entity-related information request from a first device for optimizing a wireless positioning AI/ML model; and
a transmitting unit configured to transmit model-related information feedback and/or entity-related information feedback to the first device.

According to another aspect of the embodiments of the present application, there is provided with a communication system, including:
a first device configured to transmit a model-related information request and/or an entity-related information request for optimizing a wireless positioning AI/ML model, and receive model-related information feedback and/or entity-related information feedback; and
a second device configured to receive the model-related information request and/or entity-related information request, and transmit model-related information response and/or entity-related information feedback.

One of the beneficial effects of the embodiments of the present application is in: a first device transmits a model-related information request and/or an entity-related information request for optimizing wireless positioning AI/ML model to a second device; and the first device receives model-related information feedback and/or entity-related information feedback transmitted by the second device. Therefore, information interaction may be carried out between network entities participating in positioning and/or between network entities and terminals, thereby achieving related model training for optimizing wireless positioning AI/ML models, resulting in better performance or generalization of the AI/ML models for wireless positioning, and thus obtaining more accurate positioning results.

With reference to the specification and drawings below, specific embodiments of the present application are disclosed in detail, which specifies the manner in which the principle of the present application may be adopted. It should be understood that, the scope of the embodiments of the present application are not limited. Within the scope of the spirit and clause of the appended claims, the embodiments of the present application include many variations, modifications and equivalents.

The features described and/or shown for one embodiment may be used in one or more other embodiments in the same or similar manner, may be combined with the features in other embodiments or replace the features in other embodiments.

It should be emphasized that, the term “include/comprise” refers to, when being used in the text, existence of features, parts, steps or assemblies, without exclusion of existence or attachment of one or more other features, parts, steps or assemblies.

### BRIEF DESCRIPTION OF THE DRAWINGS

Elements and features described in one of the drawings or embodiments of the present application may be combined with the elements and features shown in one or more other drawings or embodiments. Moreover, in the drawings, similar reference signs indicate corresponding parts in several drawings and may be used to indicate corresponding parts used in more than one embodiment.

The included drawings are used for providing further understanding on the embodiments of the present application, constitute a portion of the Description, are used for illustrating the embodiments of the present application and explain the principle of the present application together with the literary description. Obviously, the drawings described below are merely some examples of the present application, persons ordinarily skilled in the art can also obtain other drawings according to these drawings without making creative efforts. In the drawings:

FIG. 1 is a schematic diagram of the application scenario of the embodiments of the present application;

FIG. 2 is a schematic diagram of an information interaction method in the embodiments of the present application;

FIG. 3 is another schematic diagram of an information interaction method in the embodiments of the present application;

FIG. 4 is another schematic diagram of an information interaction method in the embodiments of the present application;

FIG. 5 is another schematic diagram of an information interaction method in the embodiments of the present application;

FIG. 6 is another schematic diagram of an information interaction method in the embodiments of the present application;

FIG. 7 is a schematic diagram of an information interaction apparatus in the embodiments of the present application;

FIG. 8 is another schematic diagram of an information interaction apparatus in the embodiments of the present application; and

FIG. 9 is a schematic diagram of an electronic device in the embodiments of the present application.

### DETAILED DESCRIPTION

With reference to the drawings, the foregoing and other features of the present application will become apparent through the following specification. The Description and drawings specifically disclose the particular embodiments of the present application, showing part of the embodiments in which the principle of the present application may be adopted, it should be understood that the present application is not limited to the described embodiment, on the contrary, the present application includes all modifications, variations and equivalents that fall within the scope of the appended claims.

In embodiments of the present application, the terms “first”, “second”, etc., are used to distinguish different elements by their appellation, but do not indicate the spatial arrangement or chronological order of these elements, etc., and these elements shall not be limited by the terms. The term “and/or” includes any and all combinations of one or more of the terms listed in association with the term. The terms “contain”, “include”, “have”, etc., refer to the presence of the stated feature, element, component or assembly, but do not exclude the presence or addition of one or more other features, elements, components or assemblies.

In the embodiments of the present application, the singular forms “one”, “the”, etc., including the plural forms, shall be broadly understood as “a sort of” or “a kind of” and not limited to the meaning of “one”; furthermore, the term “said” shall be understood to include both the singular form and the plural form, unless it is expressly indicated otherwise in the context. In addition, the term “according to” should be understood to mean “at least partially according to . . . ”, and the term “based on” should be understood to mean “based at least partially on . . . ”, unless it is expressly indicated otherwise in the context.

In embodiments of the present application, the term “communications network” or “wireless communications network” may refer to a network that complies with any of the following communication standards, such as Long Term Evolution (LTE), Enhanced Long Term Evolution (LTE-A), Wideband Code Division Multiple Access (WCDMA), High-Speed Packet Access (HSPA), etc.

In addition, the communication between the devices in the communication system may be carried out according to the communication protocol of any stage, for example, including but not being limited to 1G (generation), 2G, 2.5G, 2.75G, 3G, 4G, 4.5G and future 5G, New Radio (NR), etc., and/or other communication protocols currently known or to be developed in the future.

In the embodiments of the present application, the term “network device” refers to, for example, a device in the communication system that connects a terminal equipment to the communication network and provides services to the terminal equipment. The network device may include but is not limited to: a base station (BS), an access point (AP), a transmission reception point (TRP), a broadcast transmitter, a mobile management entity (MME), a gateway, a server, a radio network controller (RNC), a base station controller (BSC), etc.

The base station may include, but is not limited to, a node B (NodeB or NB), an evolution node B (eNodeB or eNB), 5G base station (gNB), an IAB donor, etc., and may also include a remote radio head (RRH), a remote radio unit (RRU), a relay, or a low-power node (such as femto, pico, etc.). And the term “base station” may include some or all of their functions, with each base station providing communication coverage to a specific geographic area. The term “cell” may refer to a base station and/or its coverage area, depending on the context in which the term is used.

In the embodiments of the present application, the term “user equipment” (UE) refers, for example, to a device that is connected to the communication network through the network device and receives network services, and may also be referred to as “Terminal Equipment” (TE). The terminal equipment may be fixed or movable, and may also be called a mobile station (MS), a terminal, a user, a subscriber station (SS), an access terminal (AT), a station, etc.

The terminal equipment may include but is not limited to: a cellular phone, a personal digital assistant (PDA), a wireless modem, a wireless communication device, a handheld device, a machine-type communication device, a laptop computer, a cordless phone, a smart phone, a smart watch, a digital camera, etc.

For another example, in scenarios such as Internet of Things (IoT), the terminal equipment may also be a machine or an apparatus that performs monitoring or measurement, and may include, but is not limited to, a machine type communication (MTC) terminal, a vehicle communication terminal, a device to device (D2D) terminal, a machine to machine (M2M) terminal, etc.

Hereinafter the scenarios of in the embodiments of the present application are illustrated by examples, but which is not limited in the present application.

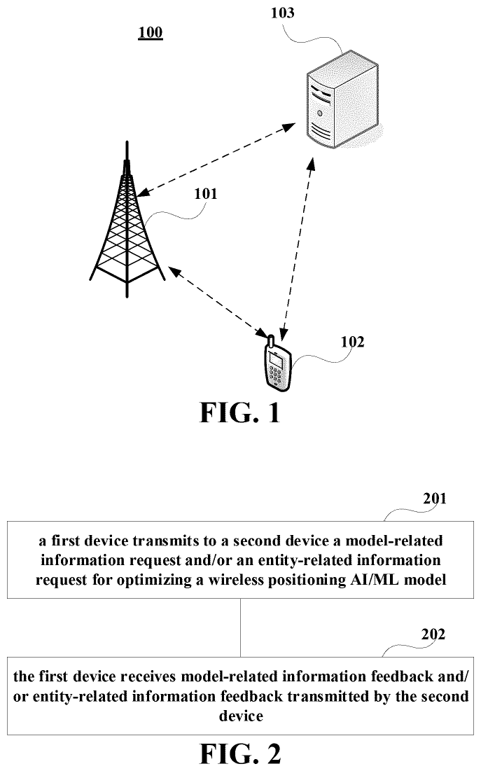

FIG. 1 is a schematic diagram of a communication system in the embodiments of the present application, illustrating the case of the terminal equipment and the network device as examples. As shown in FIG. 1, the communication system 100 may include a network device 101, a terminal equipment 102 and a location server 103. For simplicity, FIG. 1 illustrates only one terminal equipment and one network device as an example, but which is not limited in the embodiments of the present application.

In the embodiments of the present application, existing services or services that may be implemented in the future may be transmitted between the network device 101 and the terminal equipment 102. For example, these services may include, but are not limited to, enhanced Mobile Broadband (eMBB), massive Machine Type Communication (mMTC), and Ultra-Reliable and Low-Latency Communication (URLLC), etc.

It is worth noting that FIG. 1 shows that the terminal equipment 102 is within the coverage of the network equipment 101, but which is not limited in the present application. The terminal equipment 102 may not be within the coverage of the network device 101. In addition, FIG. 1 illustrates the deployment of the location server 103 alone as an example, where an AI model may be run in the location server 103 to obtain location results; but the present application is not limited to this, and the location server 103 may be deployed in the core network, or in the network device 102 (such as a base station), or in the terminal equipment 103, which are not limited in the embodiments of the present application.

In the embodiments of the present application, a terminal equipment to be located may be referred to as a target device, and the function of the location server may be referred to as Location Management Function (LMF). LMF may refer to a network entity that locates and manages the terminal, or a location server with location and management functions may be abbreviated as LMF, or a location server refers to an entity that includes LMF and has location calculation and management functions. For the specific content of these concepts and positioning, please refer to relevant technologies.

In the embodiments of the present application, the AI/ML model used for positioning may be deployed on the network device or the terminal equipment. The usual situations for model training include: in the early stage of training, the longer the training time is, the more rounds there are, the higher the improvement in model accuracy is. However, after multiple rounds of training (EPOCH), the performance tends to be stable, and in some cases, the performance may show irregular fluctuations or regression. Therefore, the cost required for model training and the gain obtained complement each other, requiring mutual interaction, comparison, and comprehensive analysis in order to select the best model training solution under current scenario requirements. The costs required for model training mainly include: time cost and resource cost.

The time cost mainly refers to the time required for model training, and its determining factors mainly include: available software and hardware resources that a model training entity may allocate (such as software versions, available algorithms, hardware capabilities), the characteristics of the model itself (such as the number of neurons of the model, structure of the model, characteristics of the backbone network), the configuration of model training parameters (such as loss function, learning rate, size of batch data), and the degree of correlation between the datasets used for fine-tuning training and initial training (or the previous one or more trainings) of the model.

The resource cost includes wireless time-frequency resources and air interface resources required for the entire training process, such as a measurement window configured during the training process, a time-frequency resource occupied by reference signals and measurement reporting, and an air interface resource occupied by signaling interaction involved in data collection and model management processes.

From this, it can be seen that the optimization management of the model training process is limited by various interdependent factors, and these kinds of information cannot all be obtained on the same network entity and a comprehensive judgment may not be made independently, requiring signaling interaction between various different network entities in the air interface.

Meanwhile, some information is mutually causal, and a signaling interaction process needs to be designed to satisfy the causal relationship and obtain final optimization solution.

### Embodiments of a First Aspect

The embodiments of the present application provide an information interaction method, which is explained from the side of a first device. The first device may be a network device (such as a base station), a terminal equipment (such as a target device or other terminals), or a location server with LMF function.

FIG. 2 is a schematic diagram of an information interaction method in the embodiments of the present application. As shown in FIG. 2, the method includes:
201: a first device transmits to a second device a model-related information request and/or an entity-related information request for optimizing a wireless positioning AI/ML model; and
202: the first device receives model-related information feedback and/or entity-related information feedback transmitted by the second device.

It is worth noting that FIG. 2 above only schematically illustrates the embodiments of the present application, but the present application is not limited to this. For example, the order of execution between operations can be adjusted appropriately, and some other operations can be added or reduced. Those skilled in the art may make appropriate variations in accordance with the above contents, and which is not limited to the disclosure of FIG. 2 above.

In some embodiments, the first device is a location server, and the second device is a terminal equipment; the location server transmits the model-related information request to the terminal equipment via LPP (LTE Positioning Protocol) signaling, and the terminal equipment transmits the model-related information feedback to the location server via LPP signaling.

For example, the UE (target device) transmits the attributes of the local model to the LMF (location server) through LPP signaling.

In some embodiments, the first device is a location server, and the second device is a base station or a network device; the location server transmits the model-related information request to the base station via NRPPa (NR Positioning Protocol A) signaling, and the base station transmits the model-related information feedback to the location server via NRPPa signaling.

For example, the gNB transmits the attributes of the local model to the LMF (location server) through NRPPa signaling.

In some embodiments, the first device is a base station or a network device, and the second device is a terminal equipment; the base station or network device transmits the model-related information request to the terminal equipment via radio resource control (RRC) signaling, and the terminal equipment transmits the model-related information feedback to the base station or network device via the RRC signaling.

For example, the UE (or target device) transmits the attributes of the local model to the gNB through RRC signaling.

In some embodiments, the first device receives request information for starting training transmitted by the second device.

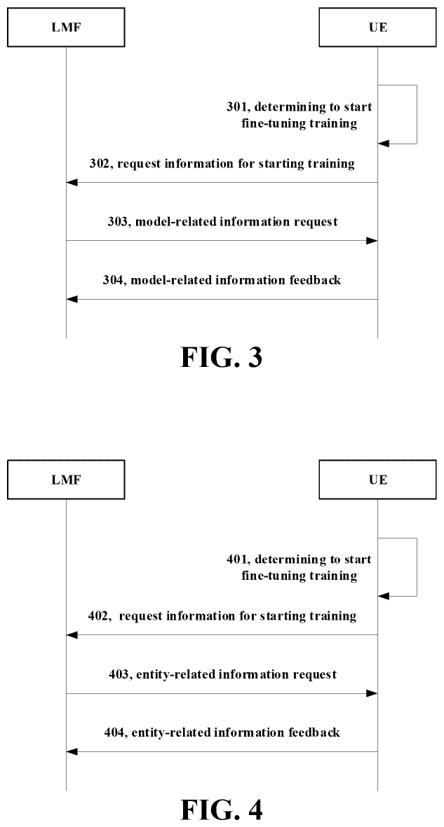

FIG. 3 is an example diagram of the information interaction method in the embodiments of the present embodiment, for example, the AI/ML model may be deployed on the UE side, the calculation and model monitoring modules are also deployed on the UE side, and the model training module is deployed on the LMF side. FIG. 3 shows an example that model attributes are transferred between UE and LMF.

As shown in FIG. 3, after the UE determines to start training (301), it may transmit request information for starting training to the LMF (302). The LMF transmits a model-related information request for optimizing a wireless positioning AI/ML model to the UE (303); in addition, the LMF receives the model-related information feedback transmitted by the UE (304).

For example, the UE performs model supervision (or referred to as monitoring) and determines to start the model training process; the UE requests the LMF to start the training process through LPP signaling; the LMF transmits the required model information to the UE through the related information request process specified in the related protocol.

It is worth noting that FIG. 3 above only schematically illustrates the embodiments of the present application, but the present application is not limited to this. For example, the order of execution between operations may be adjusted appropriately, and some other operations may be added or reduced. Those skilled in the art may make appropriate variations in accordance with the above contents, and which is not limited to the disclosure of FIG. 3 above.

In some embodiments, the model-related information (or also referred to as model capability information, model attachment information, training-specific information, etc., used to provide assistance for model training) request and/or the model-related information feedback include(s): neural network model basic information and/or neural network model-related information.

For example, the neural network model basic information includes at least one of the following: model size information, model type information, model format information, model layer information, information on a storage space needed by the model, information on the number of neurons per layer, information on an organization mode of neurons, or information on an arrangement mode of neurons; and the neural network model-related information includes information on a model encoding mode and/or information on a model storage format.

In some embodiments, the model-related information request and/or the model-related information feedback include(s) at least one of the following: model input information, statistical information corresponding to model input data, model output information, or statistical information corresponding to model output data or other data.

For example, the model input information includes at least one of the following: a model input type, time needed in training the model, or an input state.

For example, the statistical information corresponding to the model input data includes at least one of the following: global power distribution information of a channel impulse response (CIR), partial power distribution information of the CIR, global time distribution information of the CIR, partial time distribution information of the CIR, average power information of the CIR, maximum power information of the CIR, first time peak information of the CIR, non-radio access technology (NON-RAT) method information, NON-RAT method delay information, reference signal received power information based on reference signal measurement, or distribution statistical information of RSRP.

For example, the statistical information corresponding to model output data or other data includes at least one of the following: Non-Light of Sight (NLOS) probability distribution information of propagation paths between a network device and a terminal equipment pair, NLOS probability proportion information, Light of Sight (LOS) probability distribution information, LOS probability proportion information, absolute distribution information of Time of Arrival (TOA) corresponding to propagation paths, relative distribution information of TOA, statistical distribution information of a Reference Signal Time Difference (RSTD) calculated from a reference source, or accuracy information of measured physical quantities of channels.

In some embodiments, the model-related information request and/or the model-related information feedback include(s) at least one of the following: model gradient optimization configuration algorithm information, model test accuracy information, model learning rate information, model convergence time information, or model loss function information.

Hereinbefore the model-related information request and/or the model-related information feedback are exemplarily illustrated, but the present application is not limited to this. For example, other information may also be included. In addition, one of the information may be used according to actual needs, or the above information may be combined arbitrarily.

In some embodiments, the interaction content may be specified through enhanced signaling of request capability. For example, taking LPP signaling as an example, LMF may specify interaction content through enhanced signaling of request capability, and the UE may report capability according to the requirement.

For example, as shown in Table 1 below, for the interaction of model-related information, RequestCapabilities/ProvideCapabilities in the existing protocol is used as a framework; for another example, as shown in Table 2 below, a new AI/ML model specific IE may also be used for the interaction of the model-related information.

TABLE 1

```
RequestCapabilities-r9-IEs::= SEQUENCE {
. . .
[[
  . . .
  nr-ModelAIMLpos-RequestCapabilities
  nr-EntityInfoAIML-RequestCapabilites
  . . .
]]
}
ProvideCapabilities-r9-IEs::= SEQUENCE {
. . .
[[
  . . .
  nr-ModelAIMLpos-ProvideCapabilities
  nr-EntityInfoAIML-ProvideCapabilites
  . . .
]]
}
```

TABLE 2

Model-RequestCapabilities::= Sequence {
. . .
}

In some embodiments, an IE example of interaction of the model-related information is as shown in Table 3 below, corresponding to the situation accompanying the interaction of model ID information, such as an IE example of the interaction of the model-related information transmitted along with the model ID, as follows:

TABLE 3
nr-ModelAIMLpos-RequestCapabilities::= SEQUENCE {
. . .

| | |
|---|---|
| ModelGlobalID | ModelGlobalID OPTIONAL |
| ModelOtherID | ModelOtherID OPTIONAL |
| ModelPosType | nr-ModelPosType OPTIONAL |

```
    . . .
}
nr-ModelAIMLpos-ProvideCapabilities ::= SEQUENCE {
  . . .
```

| | |
|---|---|
| nr-ModelPosType | ENUMERATED {direct, assisted} |
| nr-ModelPosInput | ENUMERATED {cir, pdp, rsrp} |
| nr-ModelPosOutput | ENUMERATED {pos-2d, pos-3d, toa, |

losnlos, }

| | |
|---|---|
| nr-ModelBasicStructure | ENUMERATED {CNN, Transformer, Hybrid, |

other}

| | |
|---|---|
| nr-ModelPosAccuracy | ::= SEQUENCE { |
| | . . . |
| | locAccuracy locAccuracy |
| | losnlosAccuracy losnlosAccuracy |
| | timingAccurcy timingAccuracy |
| | angleAccuracy angleAccuracy |
| | . . . |
| | } |

```
  locAccuracy . . .
  losnlosAccuracy . . .
  timingAccuracy . . .
  angleAccuracy . . .
```

| | |
|---|---|
| nr-ModelAssistanceInfoProvide | ::= SEQUENCE { |
| | . . . |
| | trainingRelated |
| | inputRelated |
| | outputRelated |
| | datasetRelated |

trainingRelated ::= SEQUENCE{

numOfEpoches
learningRate
LossFunction
. . .

InputRelated ::= SEQUENCE{

cirAssistanceInfo
rsrpAsstanceInfo
pdpAssistanceInfo
. . .

```
      }
  OutputRelated:: = SEQUENCE{
```

GTavailability
Accuracy
. . .

DatasetRelated:: = SEQUENCE{

ExpecgtedDataSize
ProcessingRequirement
. . .

```
  }
  . . .
}
```

In some embodiments, an IE example of interaction of the model-related information is as shown in Table 4 below, corresponding to the case of interaction as mode additional information. For example, an IE example transmitted through model additional information is as follows:

TABLE 4

| ModelAdditionalInfo::= Sequence { | |
|---|---|
| ModelType | ENUMERATED {CNN, DNN, RNN, Transformer, . . .} |
| ModelLayerInfo ModelLayerInfo | |
| ModelFormat | ENUMERATED {ONNX, TF, Pytorch, keras . . .} |
| ModelSize | ModelSize |

. . .
}

Tables 3 and 4 only exemplarily illustrate some cases of model-related information interaction, and the present application is not limited to this. The specific contents of Tables 3 and 4 may contain each other, and other forms of model-related information interaction may also be used, which is not limited in the present application.

Another IE example for the model-related information interaction is shown in Table 5, using model input information as an example for illustration.

TABLE 5
ModelInputInfo::= Sequence {

| | |
|---|---|
| ModelInputType | ENUMERATED { L1_RSRP, RSRPP, CIR, CFR, TOA, |

TDOA, Others }
ModelTraningTimeUsed ENUMERATED{0, 10, 20, . . .,20000}

| | |
|---|---|
| InputStats | ENUMERATED {CIR_INFO, CFR_INFO, TDOA_INFO, . . .} |

. . .
}

Another IE example for the model-related information interaction is shown in Table 6, using CIR information as an example for illustration.

TABLE 6

| CIR_INFO::= Sequence { | |
|---|---|
| CIR-AVERAGE-POWER | . . . |
| CIR-MAX-POWER | . . . |
| CIR-TimeDistribution | . . . |
| CIR-FirstPeak | . . . |

. . .
}

Another IE example for the model-related information interaction is shown in Table 7, using NON-RAT information as an example for illustration.

TABLE 7

```
NonRATInfo ::= Sequence {
  NonRATMethod ENUMERATED {gnss, lidar, wifi, . . .}
  NonRATMethodLatency ENUMERATED{0, 0.01, 0.1, . . .}
  . . .
}
```

Hereinbefore interaction of the model-related information is exemplarily illustrated, but the present application is not limited to this. New IEs may also be defined or other IEs may be reused for model-related information interaction.

Hereinbefore interaction of the model-related information is exemplarily illustrated, and hereinafter interaction of the entity-related information is illustrated.

In some embodiments, the first device is a location server, and the second device is a terminal equipment, the location server transmits an entity-related information request of the location server to the terminal equipment via LPP signaling, and the terminal equipment transmits the entity-related information feedback to the location server via LPP signaling.

For example, the LMF (location server) transmits the inherent attributes of its own entity or the attributes corresponding to the model to the UE (target device) through LPP signaling.

In some embodiments, the first device is a location server, and the second device is a base station or a network device; the location server transmits an entity-related information request of the location server to the base station or network device via NRPPa signaling, and the base station or network device transmits entity-related information feedback to the location server via NRPPa signaling.

For example, the LMF (location server) transmits the inherent attributes of its own entity or the attributes corresponding to the model to the gNB through NRPPa signaling.

In some embodiments, the first device is a base station or a network device, and the second device is a terminal equipment; the base station or network device transmits an entity-related information request of the base station or network device to the terminal equipment via RRC signaling or downlink control information (DCI), and the terminal equipment transmits the entity-related information feedback to the base station or network device via RRC signaling.

For example, the gNB transmits the inherent attributes of its own entity or the attributes corresponding to the model to the UE (target device) through RRC/DCI signaling etc.

In some embodiments, the first device is a base station or a network device, and the second device is a location server; the base station or network device transmits an entity-related information request of the base station or network device to the location server via NRPPa signaling, and the location server transmits the entity-related information feedback to the base station or network device via NRPPa signaling.

For example, the gNB transmits the inherent attributes of its own entity or the attributes corresponding to the model to the LMF (location server) through NRPPa signaling.

In some embodiments, the first device receives request information for starting training transmitted by the second device.

FIG. 4 is an example diagram of the information interaction method in the embodiments of the present embodiment, for example, the AI/ML model may be deployed on the UE side, the calculation and model monitoring modules are also deployed on the UE side, and the training module is deployed on the LMF side. FIG. 4 shows an example that entity attributes are transferred between UE and LMF.

As shown in FIG. 4, after the UE determines to start training (401), it may transmit request information for starting training to the LMF (402). The LMF transmits an entity-related information request for optimizing a wireless positioning AI/ML model to the UE (403); in addition, the LMF receives the entity-related information feedback transmitted by the UE (404).

It is worth noting that FIG. 4 above only schematically illustrates the embodiments of the present application, but the present application is not limited to this. For example, the order of execution between operations can be adjusted appropriately, and some other operations can be added or reduced. Those skilled in the art may make appropriate variations in accordance with the above contents, and which is not limited to the disclosure of FIG. 4 above.

In some embodiments, the entity-related information (or also referred to as entity capability information, entity attachment information, training-specific information, etc., used to provide assistance for model training) request includes at least one of the following: hardware capability information, entity state information, model training software version information, training permission information, training adjustment information, or training rejection information. The present application is not limited to this, and any combination of the above information may be used, or other information may also be included.

For example, the UE performs model supervision and determines to start the training process; the LMF transmits local entity information to the UE, which may include: local software and hardware resource information or local comprehensive time-frequency resource allocation information. Based on the comprehensive judgment and suggestions made according to the above capabilities, for example, if the hardware capability requirements are too high, a signaling to refuse to start the training may be directly transmitted.

In some embodiments, the entity-related information feedback includes at least one of the following: training data collection information, data configuration information, training re-request information, information on a request for transmitting more entity capabilities, information on a request for initiating model selection, or information on a request for initiating fallback. The present application is not limited to this, and any combination of the above information may be used, or other information may also be included.

For example, the FEEDBACK performed by the UE based on the related information of the LMF may include: management signaling for the training process, such as pause, termination; signaling for data collection and configuration corresponding to the training process; signaling in terms of other comprehensive capabilities.

In some embodiments, the interaction content may be specified through enhanced signaling of request capability. For example, taking LPP signaling as an example, LMF may specify interaction content through enhanced signaling of request capability, and the UE may report capability according to the requirement.

An IE example of the entity-related information interaction in the manner shown in Table 1 is shown in Table 8:

TABLE 8

```
  nr-EntityInfoAIML -RequestCapabilites ::= SEQUENCE {
    ......
  }
  nr-EntityInfoAIML -ProvideCapabilites ::= SEQUENCE {
    ......
    nr-ResourcesAvailability ::= SEQUENCE{
```

hardwareInfo
softwareInfo

......
}

Hereinbefore interaction of the entity-related information is exemplarily illustrated, but the present application is not limited to this. New IEs may also be defined or other IEs may be reused for entity-related information interaction.

Hereinbefore interaction of the model-related information and interaction of the entity-related information is exemplarily illustrated, and hereinafter assistant information interaction is illustrated.

In some embodiments, the first device transmits assistant information for AI/ML model training to the second device; and the first device receives feedback information transmitted by the second device.

In some embodiments, the first device is a location server, and the second device is a terminal equipment; the location server transmits the assistant information to the terminal equipment via LPP signaling, and the terminal equipment transmits the feedback information to the location server via LPP signaling.

For example, the LMF (location server) transmits assistant information or decision information to the UE (target device) through LPP signaling.

In some embodiments, the first device is a location server, and the second device is a base station or a network device; the location server transmits the assistant information to the base station via NRPPa signaling, and the base station or network device transmits the feedback information to the location server via NRPPa signaling.

For example, the LMF (location server) transmits assistant information or decision information to the gNB through NRPPa signaling.

In some embodiments, the first device is a base station or a network device, and the second device is a terminal equipment; the base station or network device transmits the assistant information to the terminal equipment via RRC signaling or DCI, and the terminal equipment transmits the feedback information to the base station or network device via RRC signaling.

For example, the gNB transmits assistant information or decision information to the UE (target device) through RRC/DCI signaling etc.

In some embodiments, the first device is a base station or network device, and the second device is a location server; the base station or network device transmits the assistant information to the location server via NRPPa signaling, and the location server transmits the feedback information to the base station or network device via NRPPa signaling.

For example, the gNB transmits assistant information or decision information to the LMF (location server) through NRPPa signaling.

In some embodiments, the interaction of assistant information may be conducted independently or combined with the aforementioned model-related information interaction and/or entity-related information interaction. For example, the first device may perform comprehensive estimation or computation based on the collected model-related information and entity-related information, and transmit additional assistant information to the second device so as to assist in training data collection or supervision or other functions.

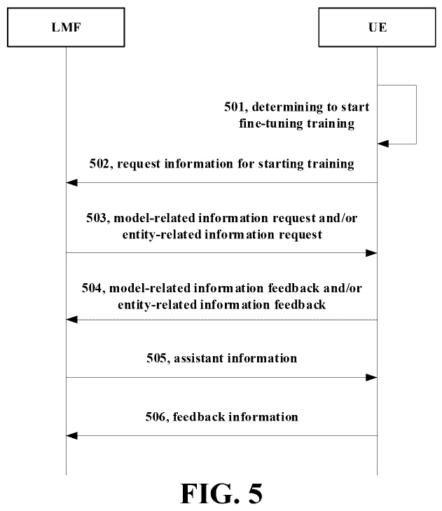

FIG. 5 is another example diagram of the information interaction method in the embodiments of the present embodiment, for example, the AI/ML model may be deployed on the UE side, the calculation and model monitoring modules are also deployed on the UE side, and the model training module is deployed on the LMF side. FIG. 5 shows an example that assistant information is transferred between UE and LMF.

As shown in FIG. 5, after the UE determines to start model training (501), it may transmit request information for starting training to the LMF (502). The LMF transmits a model-related information request and/or an entity-related information request for optimizing a wireless positioning AI/ML model to the UE (503); in addition, the LMF receives model-related information feedback and/or entity-related information feedback transmitted by the UE (504).

As shown in FIG. 5, the LMF transmits the assistant information for optimizing a wireless positioning AI/ML model to the UE (505); in addition, the LMF receives the feedback information transmitted by the UE (506).

For example, the UE performs model supervision and determines to start the training process; the LMF and the UE performs information interaction; the LMF obtains assistant information that may be used to support data collection or model optimization training based on the reported and locally known related information, and transmits it to the UE.

It is worth noting that FIG. 5 above only schematically illustrates the embodiments of the present application, but the present application is not limited to this. For example, the order of execution between operations can be adjusted appropriately, and some other operations can be added or reduced. Those skilled in the art may make appropriate variations in accordance with the above contents, and which is not limited to the disclosure of FIG. 5 above.

In some embodiments, the assistant information includes at least one of the following: time needed in model training, resource overhead needed in model training, accuracy achievable for model training, time needed in data collection, model training strategy configuration information, training time estimation information, training accuracy estimation information, training data collection time estimation information, or training resource estimation information. The present application is not limited to this, and any combination of the above information may be used, or other information may also be included.

For example, the content of the assistant information may include: the time required for the model to complete training (a single round or multiple rounds); resource overhead needed in model training; approximate model accuracy that may be achieved through model training; approximate time required for data collection. The UE performs data collection or model training configuration or other signaling interactions based on the received assistant information.

In some embodiments, the assistant information interaction may be achieved through RequestAssistanceData and Provide AssistanceData. An IE example for assistant information interaction is shown in Table 9:

TABLE 9
NR-AIPOS-RequestAssistanceData::= SEQUENCE {
......

| | |
|---|---|
| nr-PhysCellID-r16 | NR-PhysCellID-r16 OPTIONAL, |
| nr-AdtypeAIpos-r18 | BIT STRING { |
| | } (SIZE (1...N)), |

```
  ......
}
NR-AIPOS-ProvideAssistanceData::= SEQUENCE {
  ......
```

| | |
|---|---|
| nr-AIPOS-dataAd-r18 | NR-AIPOS-dataAd-r18 |
| nr-AIPOS-modeltrainingAd-r18 | NR-AIPOS-modelTrainingAd- |

r18
......
}

In some embodiments, assistant information interaction may be achieved through ModelTrainingAssistanceInfo. An IE example for assistant information interaction is shown in Table 10:

TABLE 10

| ModelTrainingAssistance Info::= SEQUENCE { | |
|---|---|
| TrainingTimeEstimated | . . . |
| TrainingAccuracyEstimated | . . . |
| TrainingDataCollectionTimeEstimated . . . | |
| TrainingResourceEstimated | . . . |

. . .
}

Hereinbefore assistant information interaction is exemplarily illustrated, but the present application is not limited to this. New IEs may also be defined or other IEs may be reused for assistant information interaction.

Hereinbefore assistant information interaction is exemplarily illustrated, and hereinafter online data interaction is illustrated.

In some embodiments, the first device receives request information transmitted by the second device for requesting online data collection, and the first device performs resource configuration according to the request information.

In some embodiments, the first device receives feedback information transmitted by the second device, wherein the second device generates the feedback information after performing reference signal measurement according to the resource configuration.

In some embodiments, the interaction of online data may be conducted independently or combined with the aforementioned model-related information interaction and/or entity-related information interaction.

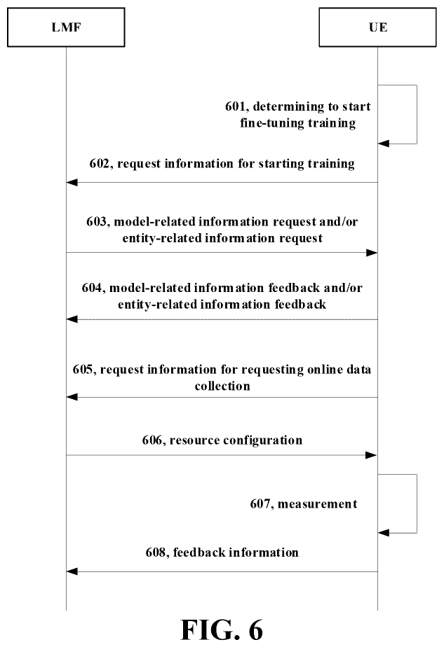

FIG. 6 is another example diagram of the information interaction method in the embodiments of the present embodiment, for example, the AI/ML model may be deployed on the UE side, the calculation and model monitoring modules are also deployed on the UE side, and the model training module is deployed on the LMF side. FIG. 6 shows an example that online data is transferred between UE and LMF.

As shown in FIG. 6, after the UE determines to start training (601), it may transmit request information for starting training to the LMF (602). The LMF transmits a model-related information request and/or an entity-related information request for optimizing a wireless positioning AI/ML model to the UE (603); in addition, the LMF receives model-related information feedback and/or entity-related information feedback transmitted by the UE (604).

As shown in FIG. 6, the UE transmits request information for requesting online data collection to the LMF (605); the LMF performs resource allocation for the UE (606), such as transmitting information of coordinating RS to the gNB and the UE; the UE performs measurement based on RS (607), the RS is transmitted to the UE by the gNB based on configuration information, for example; in addition, the LMF receives feedback information transmitted by the UE (608).

It is worth noting that FIG. 6 above only schematically illustrates the embodiments of the present application, but the present application is not limited to this. For example, the order of execution between operations can be adjusted appropriately, and some other operations can be added or reduced. Those skilled in the art may make appropriate variations in accordance with the above contents, and which is not limited to the disclosure of FIG. 6 above.

In some embodiments, the request information further includes at least one of the following: sample data amount expectation information, data dimension information, data collection time length threshold information, data accuracy expectation information, reference signal configuration information of data collection, or reference signal selection information of data collection. The present application is not limited to this, and any combination of the above information may be used, or other information may also be included.

In some embodiments, the feedback information includes at least one of the following: data collection termination information, data recollection information, data collection failure information, initiating model selection information, or initiation fallback information. The present application is not limited to this, and any combination of the above information may be used, or other information may also be included.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, a first device transmits a model-related information request and/or an entity-related information request for optimizing wireless positioning AI/ML model to a second device; and the first device receives model-related information feedback and/or entity-related information feedback transmitted by the second device. Therefore, information interaction may be carried out between network entities participating in positioning and/or between network entities and terminals, thereby achieving customized training for optimizing wireless positioning AI/ML models, resulting in better performance or generalization of the AI/ML models for wireless positioning, and thus obtaining more accurate positioning results.

### Embodiments of a Second Aspect

The embodiments of the present application provide an information interaction method, which is explained from the side of a second device. The embodiments of the second aspect correspond to that of the first aspect, and the same content will not be repeated.

In the embodiments of the present application, a second device receives model-related information request and/or entity-related information request from a first device for optimizing a wireless positioning AI/ML model; and the second device transmits model-related information feedback and/or entity-related information feedback to the first device.

In some embodiments, the first device is a location server, and the second device is a terminal equipment; the location server transmits the model-related information request to the terminal equipment via LPP signaling, and the terminal equipment transmits the model-related information feedback to the location server via LPP signaling.

In some embodiments, the first device is a location server, and the second device is a base station or a network device; the location server transmits the model-related information request to the base station via NRPPa signaling, and the base station transmits the model-related information feedback to the location server via NRPPa signaling.

In some embodiments, the first device is a base station or a network device, and the second device is a terminal equipment; the base station or network device transmits the model-related information request to the terminal equipment via RRC signaling, and the terminal equipment transmits the model-related information feedback to the base station or network device via RRC signaling.

In some embodiments, the method further includes: the second device transmitting request information for starting training to the first device.

In some embodiments, the model-related information request and/or the model-related information feedback include(s): neural network model basic information and/or neural network model-related information.

In some embodiments, the neural network model basic information includes at least one of the following: model size information, model type information, model format information, model layer information, information on a storage space needed by the model, information on the number of neurons per layer, information on an organization mode of neurons, or information on an arrangement mode of neurons;

and the neural network model-related information includes information on a model encoding mode and/or information on a model storage format.

In some embodiments, the model-related information request and/or the model-related information feedback include(s) at least one of the following: model input information, statistical information corresponding to model input data, model output information, or statistical information corresponding to model output data or other data.

In some embodiments, the model input information includes at least one of the following: a model input type, time needed in training the model, or an input state.

In some embodiments, the statistical information corresponding to the model input data includes at least one of the following: global power distribution information of a channel impulse response (CIR), partial power distribution information of the CIR, global time distribution information of the CIR, partial time distribution information of the CIR, average power information of the CIR, maximum power information of the CIR, first time peak information of the CIR, NON-RAT method information, NON-RAT method delay information, reference signal received power (RSRP) information based on reference signal measurement, or distribution statistical information of RSRP.

The statistical information corresponding to model output data or other data includes at least one of the following: Non-Light of Sight (NLOS) probability distribution information of propagation paths between a network device and a terminal equipment pair, NLOS probability proportion information, Light of Sight (LOS) probability distribution information, LOS probability proportion information, absolute distribution information of Time of Arrival (TOA) corresponding to propagation paths, relative distribution information of TOA, statistical distribution information of a Reference Signal Time Difference (RSTD) calculated from a reference source, or accuracy information of measured physical quantities of channels.

In some embodiments, the model-related information request and/or the model-related information feedback include(s) at least one of the following: model gradient optimization configuration algorithm information, model test accuracy information, model learning rate information, model convergence time information, or model loss function information.

In some embodiments, the first device is a location server, and the second device is a terminal equipment; the location server transmits an entity-related information request of the location server to the terminal equipment via LPP signaling, and the terminal equipment transmits the entity-related information feedback to the location server via LPP signaling.

In some embodiments, the first device is a location server, and the second device is a base station or a network device; the location server transmits an entity-related information request of the location server to the base station or network device via NRPPa signaling, and the base station or network device transmits entity-related information feedback to the location server via NRPPa signaling.

In some embodiments, the first device is a base station or a network device, and the second device is a terminal equipment; the base station or network device transmits an entity-related information request of the base station or network device to the terminal equipment via RRC signaling or DCI, and the terminal equipment transmits the entity-related information feedback to the base station or network device via RRC signaling.

In some embodiments, the first device is a base station or a network device, and the second device is a location server; the base station or network device transmits an entity-related information request of the base station or network device to the location server via NRPPa signaling, and the location server transmits the entity-related information feedback to the base station or network device via NRPPa signaling.

In some embodiments, the method further includes: the second device transmitting request information for starting training to the first device.

In some embodiments, the entity-related information request includes at least one of the following: hardware capability information, entity state information, model training software version information, training permission information, training adjustment information, or training rejection information.

In some embodiments, the entity-related information feedback includes at least one of the following: training data collection information, data configuration information, training re-request information, information on a request for transmitting more entity capabilities, information on a request for initiating model selection, or information on a request for initiating fallback.

In some embodiments, the method further includes: the second device receiving assistant information for AI/ML model training from the first device; and the second device transmitting feedback information to the first device.

In some embodiments, the first device is a location server, and the second device is a terminal equipment; the location server transmits the assistant information to the terminal equipment via LPP signaling, and the terminal equipment transmits the feedback information to the location server via LPP signaling.

In some embodiments, the first device is a location server, and the second device is a base station or a network device; the location server transmits the assistant information to the base station via NRPPa signaling, and the base station or network device transmits the feedback information to the location server via NRPPa signaling.

In some embodiments, the first device is a base station or a network device, and the second device is a terminal equipment; the base station or network device transmits the assistant information to the terminal equipment via RRC signaling or DCI, and the terminal equipment transmits the feedback information to the base station or network device via RRC signaling.

In some embodiments, the first device is a base station or network device, and the second device is a location server; the base station or network device transmits the assistant information to the location server via NRPPa signaling, and the location server transmits the feedback information to the base station or network device via NRPPa signaling.

In some embodiments, the assistant information includes at least one of the following: time needed in model training, resource overhead needed in model training, accuracy achievable for model training, time needed in data collection, model training strategy configuration information, training time estimation information, training accuracy estimation information, training data collection time estimation information, or training resource estimation information.

In some embodiments, the method further includes: the second device transmitting request information to the first device for requesting online data collection, wherein the first device performs resource configuration according to the request information.

In some embodiments, the request information further includes at least one of the following: sample data amount expectation information, data dimension information, data collection time length threshold information, data accuracy expectation information, reference signal configuration information of data collection, or reference signal selection information of data collection.

In some embodiments, the method further includes: the second device generating feedback information after performing reference signal measurement according to the resource configuration; and the second device transmitting the feedback information to the first device.

In some embodiments, the feedback information includes at least one of the following: data collection termination information, data recollection information, data collection failure information, initiating model selection information, or initiation fallback information.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, a first device transmits a model-related information request and/or an entity-related information request for optimizing wireless positioning AI/ML model to a second device; and the first device receives model-related information feedback and/or entity-related information feedback transmitted by the second device. Therefore, information interaction may be carried out between network entities participating in positioning and/or between network entities and terminals, thereby achieving customized training for optimizing wireless positioning AI/ML models, resulting in better performance or generalization of the AI/ML models for wireless positioning, and thus obtaining more accurate positioning results.

### Embodiments of a Third Aspect

The embodiments of the present application provide an information interaction apparatus that may, for example, be a first device described above, or some one or more components or assemblies configured on the first device.

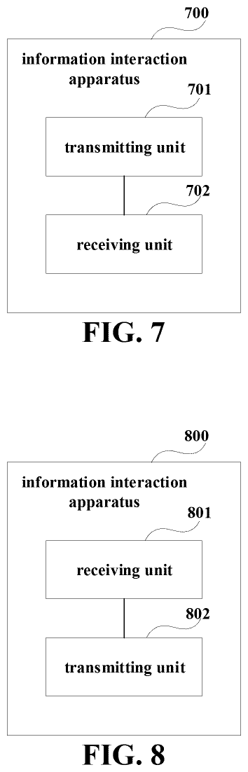

FIG. 7 is a schematic diagram of an information interaction apparatus in the embodiments of the present application. Since the principle for the information interaction apparatus to solve the problem is the same as the method of the embodiments of the first aspect, the specific implementation may be realized referring to the embodiments of the first aspect, and the same contents will not be repeated.

As shown in FIG. 7, an information interaction apparatus 700 of the embodiments of the present application includes:
a transmitting unit 701 (or referred to as a transmitter) configured to transmit a model-related information request and/or an entity-related information request for optimizing a wireless positioning AI/ML model to a second device; and
a receiving unit 702 (as referred to as a receiver) configured to receive model-related information feedback and/or entity-related information feedback transmitted by the second device.

In some embodiments, the first device is a location server, and the second device is a terminal equipment; the location server transmits the model-related information request to the terminal equipment via LPP signaling, and the terminal equipment transmits the model-related information feedback to the location server via LPP signaling;
or, the first device is a location server, and the second device is a base station or a network device; the location server transmits the model-related information request to the base station via NRPPa signaling, and the base station transmits the model-related information feedback to the location server via NRPPa signaling;
or, the first device is a base station or a network device, and the second device is a terminal equipment; the base station or network device transmits the model-related information request to the terminal equipment via RRC signaling, and the terminal equipment transmits the model-related information feedback to the base station or network device via the RRC signaling.

In some embodiments, the receiving unit 702 further receives request information for starting training transmitted by the second device.

In some embodiments, the model-related information request and/or the model-related information feedback include(s): neural network model basic information and/or neural network model-related information.

In some embodiments, the neural network model basic information includes at least one of the following: model size information, model type information, model format information, model layer information, information on a storage space needed by the model, information on the number of neurons per layer, information on an organization mode of neurons, or information on an arrangement mode of neurons;
and the neural network model-related information includes information on a model encoding mode and/or information on a model storage format.

In some embodiments, the model-related information request and/or the model-related information feedback include(s) at least one of the following: model input information, statistical information corresponding to model input data, model output information, or statistical information corresponding to model output data or other data.

In some embodiments, the model input information includes at least one of the following: a model input type, time needed in training the model, or an input state.

In some embodiments, the statistical information corresponding to the model input data includes at least one of the following: global power distribution information of a channel impulse response (CIR), partial power distribution information of the CIR, global time distribution information of the CIR, partial time distribution information of the CIR, average power information of the CIR, maximum power information of the CIR, first time peak information of the CIR, NON-RAT method information, NON-RAT method delay information, reference signal received power (RSRP) information based on reference signal measurement, or distribution statistical information of RSRP.

The statistical information corresponding to model output data or other data includes at least one of the following: Non-Light of Sight (NLOS) probability distribution information of propagation paths between a network device and a terminal equipment pair, NLOS probability proportion information, Light of Sight (LOS) probability distribution information, LOS probability proportion information, absolute distribution information of Time of Arrival (TOA) corresponding to propagation paths, relative distribution information of TOA, statistical distribution information of a Reference Signal Time Difference (RSTD) calculated from a reference source, or accuracy information of measured physical quantities of channels.

In some embodiments, the model-related information request and/or the model-related information feedback include(s) at least one of the following: model gradient optimization configuration algorithm information, model test accuracy information, model learning rate information, model convergence time information, or model loss function information.

In some embodiments, the first device is a location server, and the second device is a terminal equipment; the location server transmits an entity-related information request of the location server to the terminal equipment via LPP signaling, and the terminal equipment transmits the entity-related information feedback to the location server via LPP signaling.
or, the first device is a location server, and the second device is a base station or a network device, the location server transmits an entity-related information request of the location server to the base station or network device via NRPPa signaling, and the base station or network device transmits entity-related information feedback to the location server via NRPPa signaling;
or, the first device is a base station or a network device, and the second device is a terminal equipment; the base station or network device transmits an entity-related information request of the base station or network device to the terminal equipment via RRC signaling or DCI, and the terminal equipment transmits the entity-related information feedback to the base station or network device via RRC signaling;
or, the first device is a base station or a network device, and the second device is a location server, the base station or network device transmits an entity-related information request of the base station or network device to the location server via NRPPa signaling, and the location server transmits the entity-related information feedback to the base station or network device via NRPPa signaling.

In some embodiments, the receiving unit 702 further receives request information for starting training transmitted by the second device.

In some embodiments, the entity-related information request includes at least one of the following: hardware capability information, entity state information, model training software version information, training permission information, training adjustment information, or training rejection information;
and the entity-related information feedback includes at least one of the following: training data collection information, data configuration information, training re-request information, information on a request for transmitting more entity capabilities, information on a request for initiating model selection, or information on a request for initiating fallback.

In some embodiments, the transmitting unit 701 further transmits assistant information for AI/ML model training to the second device; and the receiving unit 702 further receives feedback information transmitted by the second device.

In some embodiments, the first device is a location server, and the second device is a terminal equipment; the location server transmits the assistant information to the terminal equipment via LPP signaling, and the terminal equipment transmits the feedback information to the location server via LPP signaling;
or, the first device is a location server, and the second device is a base station or a network device; the location server transmits the assistant information to the base station via NRPPa signaling, and the base station or network device transmits the feedback information to the location server via NRPPa signaling;
or, the first device is a base station or a network device, and the second device is a terminal equipment; the base station or network device transmits the assistant information to the terminal equipment via RRC signaling or DCI, and the terminal equipment transmits the feedback information to the base station or network device via RRC signaling;
or, the first device is a base station or network device, and the second device is a location server; the base station or network device transmits the assistant information to the location server via NRPPa signaling, and the location server transmits the feedback information to the base station or network device via NRPPa signaling.

In some embodiments, the assistant information includes at least one of the following: time needed in model training, resource overhead needed in model training, accuracy achievable for model training, time needed in data collection, model training strategy configuration information, training time estimation information, training accuracy estimation information, training data collection time estimation information, or training resource estimation information.

In some embodiments, the receiving unit 702 further receives request information transmitted by the second device for requesting online data collection; and the first device performs resource configuration according to the request information.

In some embodiments, the request information further includes at least one of the following: sample data amount expectation information, data dimension information, data collection time length threshold information, data accuracy expectation information, reference signal configuration information of data collection, or reference signal selection information of data collection.

In some embodiments, the receiving unit 702 further receives feedback information transmitted by the second device, wherein the second device generates the feedback information after performing reference signal measurement according to the resource configuration.

In some embodiments, the feedback information includes at least one of the following: data collection termination information, data recollection information, data collection failure information, initiating model selection information, or initiation fallback information.

In addition, for the sake of simplicity, FIG. 7 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, which is not limited in the present application.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, a first device transmits a model-related information request and/or an entity-related information request for optimizing wireless positioning AI/ML model to a second device; and the first device receives model-related information feedback and/or entity-related information feedback transmitted by the second device.

Therefore, information interaction may be carried out between network entities participating in positioning and/or between network entities and terminals, thereby achieving customized training for optimizing wireless positioning AI/ML models, resulting in better performance or generalization of the AI/ML models for wireless positioning, and thus obtaining more accurate positioning results.

### Embodiments of a Fourth Aspect

The embodiments of the present application provide an information interaction apparatus that may, for example, be a second device described above, or some one or more components or assemblies configured on the second device.

FIG. 8 is a schematic diagram of an information interaction apparatus in the embodiments of the present application. Since the principle for the information interaction apparatus to solve the problem is the same as the method of the embodiments of the second aspect, the specific implementation may be realized referring to the embodiments of the first and second aspects, and the same contents will not be repeated.

As shown in FIG. 8, an information interaction apparatus 800 of the embodiments of the present application includes:
a receiving unit 801 configured to receive model-related information request and/or entity-related information request from a first device for optimizing a wireless positioning AI/ML model; and
a transmitting unit 802 configured to transmit model-related information feedback and/or entity-related information feedback to the first device.

In addition, for the sake of simplicity, FIG. 8 only exemplarily shows the connection relationship or signal trend between the individual components or modules, but it should be clear to those skilled in the art that various related techniques such as bus connections may be employed. The above individual components or modules may be implemented by hardware facilities such as a processor, a memory, a transmitter, a receiver, etc., which is not limited in the present application.

The embodiments above only schematically illustrate the embodiments of the present application, but the present application is not limited to this, and appropriate variations may also be made on the basis of the above embodiments. For example, the above embodiments may be used separately, or one or more of the above embodiments may be combined.

According to the embodiments of the present application, a first device transmits a model-related information request and/or an entity-related information request for optimizing wireless positioning AI/ML model to a second device; and the first device receives model-related information feedback and/or entity-related information feedback transmitted by the second device. Therefore, information interaction may be carried out between network entities participating in positioning and/or between network entities and terminals, thereby achieving customized training for optimizing wireless positioning AI/ML models, resulting in better performance or generalization of the AI/ML models for wireless positioning, and thus obtaining more accurate positioning results.

### Embodiments of a Fifth Aspect

The embodiments of the present application provide a communication system. FIG. 1 is a schematic diagram of the communication system of the embodiments of the present application. As shown in FIG. 1, the communication system 100 includes a network device 101, a terminal equipment 102 and a location server 103. For the sake of simplicity, FIG. 1 gives exemplary illustration by taking only one network device and one terminal equipment as an example, but the embodiments of the present application are not limited to this.

In some embodiments, the communication system includes:
a first device configured to transmit a model-related information request and/or an entity-related information request for optimizing a wireless positioning AI/ML model, and receive model-related information feedback and/or entity-related information feedback; and
a second device configured to receive the model-related information request and/or entity-related information request, and transmit model-related information feedback and/or entity-related information feedback.

The embodiments of the present application further provide an electronic device. The electronic device is, for example, a first device or a second device described above.

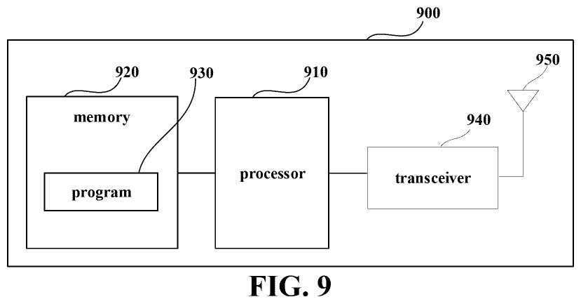

FIG. 9 is a schematic diagram of composition of the electronic device in the embodiments of the present application. As shown in FIG. 9, an electronic device 900 may include a processor 910 (such as a central processing unit (CPU)) and a memory 920; the memory 920 is coupled to the processor 910. The memory 920 may store various data and also may store the information processing program 930, and the program 930 is executed under the control of the processor 910.

For example, the processor 910 may be configured to execute the program to implement the information interaction method as described in the embodiments of the first aspect. For example, the processor 910 may be configured to perform the following controls of: transmitting a model-related information request and/or an entity-related information request for optimizing wireless positioning AI/ML model to a second device; and receiving model-related information feedback and/or entity-related information feedback transmitted by the second device.

For another example, the processor 910 may be configured to execute the program to implement the information interaction method as described in the embodiments of the second aspect. For example, the processor 910 may be configured to perform the following controls of: receiving model-related information request and/or entity-related information request from a first device for optimizing a wireless positioning AI/ML model; and transmitting model-related information feedback and/or entity-related information feedback to the first device.

In addition, as shown in FIG. 9, the electronic device 900 may further include: a transceiver 940 and an antenna 950, etc., wherein the functions of the above components are similar to the related art, and will not be repeated here. It is worth noting that the electronic device 900 is not necessarily required to include all of the components shown in FIG. 9; in addition, the electronic device 900 may further include components not shown in FIG. 9, with reference to the related art.

The embodiments of the present application further provide a computer readable program which, when being executed in a first device, causes the computer to execute the information interaction method described in the embodiments of the first aspect in the first device.

The embodiments of the present application further provide a storage medium storing a computer readable program which causes the computer to execute the information interaction method described in the embodiments of the first aspect in the first device.

The embodiments of the present application further provide a computer readable program which, when being executed in a second device, causes the computer to execute the information interaction method described in the embodiments of the second aspect in the second device.

The embodiments of the present application further provide a storage medium storing a computer readable program which causes the computer to execute the information interaction method described in the embodiments of the second aspect in the second device.

The above devices and methods of the present application can be implemented by hardware or by hardware combined with software. The present application relates to a computer readable program which, when being executed by a logic unit, enables the logic unit to implement the devices or components mentioned above, or enables the logic unit to implement the methods or steps described above. The logic unit is, for example, a field programmable logic unit, a microprocessor, a processor used in the computer, etc. The present application also relates to storage medium for storing the above programs, such as a hard disk, a magnetic disk, a compact disc, a DVD, a flash memory, etc.

The method/device described in conjunction with the embodiments of the present application may be directly embodied as hardware, a software module executed by the processor, or a combination of both. For example, one or more of the functional block diagrams and/or combination thereof shown in the drawing may correspond to both software modules and hardware modules of the computer program flow. These software modules can correspond to the steps shown in the drawings respectively. These hardware modules can be realized, for example, by solidifying these software modules using field programmable gate arrays (FPGA).

The software module may reside in an RAM memory, a flash memory, an ROM memory, an EPROM memory, an EEPROM memory, a register, a hard disk, a removable disk, a CD-ROM, or a storage medium in any other form known in the art. A storage medium can be coupled to a processor so that the processor can read information from the storage medium and write information to the storage medium; or the storage medium can be a constituent part of the processor. The processor and the storage medium can be located in the ASIC. The software module can be stored in the memory of the mobile terminal or in a memory card that can be inserted into the mobile terminal. For example, if a device (such as a mobile terminal) uses a large-capacity MEGA-SIM card or a large-capacity flash memory device, the software module can be stored in the MEGA-SIM card or the large-capacity flash memory device.

One or more of the functional blocks and/or combination thereof shown in the drawing may be implemented as a general-purpose processor, a digital signal processor (DSP), an application-specific integrated circuit (ASIC), a field programmable gate array (FPGA) or other programmable logic device, a discrete gate or a transistor logic device, a discrete hardware component, or any appropriate combination thereof, for performing the functions described in the present application. One or more of the functional blocks and/or combination thereof shown in the drawing may also be implemented as combination of computing devices, such as combination of DSP and a microprocessor, multiple microprocessors, one or more microprocessors combined with DSP communication, or any other such configuration.

The present application is described in combination with specific embodiments hereinabove, but a person skilled in the art should know clearly that the description is exemplary, but not limitation to the protection scope of the present application. A person skilled in the art can make various variations and modifications to the present application according to spirit and principle of the application, and these variations and modifications should also be within the scope of the present application.

With respect to the above-mentioned embodiments disclosed in the embodiment, the following supplements are further disclosed:

1. An information interaction method, including:
a first device transmitting to a second device a model-related information request and/or an entity-related information request for optimizing a wireless positioning AI/ML model; and
the first device receiving model-related information feedback and/or entity-related information feedback transmitted by the second device.

2. The method according to the supplement 1, wherein the first device is a location server, and the second device is a terminal equipment; the location server transmits the model-related information request to the terminal equipment via LPP signaling, and the terminal equipment transmits the model-related information feedback to the location server via LPP signaling.

3. The method according to the supplement 1, wherein the first device is a location server, and the second device is a base station or a network device; the location server transmits the model-related information request to the base station via NRPPa signaling, and the base station transmits the model-related information feedback to the location server via NRPPa signaling.

4. The method according to the supplement 1, wherein the first device is a base station or a network device, and the second device is a terminal equipment; the base station or network device transmits the model-related information request to the terminal equipment via RRC signaling, and the terminal equipment transmits the model-related information feedback to the base station or network device via the RRC signaling.

5. The method according to any of the supplements 2 to 4, wherein the method further includes:
the first device receiving request information for starting training transmitted by the second device.

6. The method according to any of the supplements 2 to 5, wherein the model-related information request and/or the model-related information feedback include(s): neural network model basic information and/or neural network model-related information.

7. The method according to the supplement 6, wherein the neural network model basic information includes at least one of the following: model size information, model type information, model format information, model layer information, information on a storage space needed by the model, information on the number of neurons per layer, information on an organization mode of neurons, or information on an arrangement mode of neurons;
and the neural network model-related information includes information on a model encoding mode and/or information on a model storage format.

8. The method according to any of the supplements 2 to 7, wherein the model-related information request and/or the model-related information feedback include(s) at least one of the following: model input information, statistical information corresponding to model input data, model output information, or statistical information corresponding to model output data or other data.

9. The method according to the supplement 8, wherein,
the model input information includes at least one of the following: a model input type, time needed in training the model, or an input state;
the statistical information corresponding to the model input data includes at least one of the following: global power distribution information of a channel impulse response (CIR), partial power distribution information of the CIR, global time distribution information of the CIR, partial time distribution information of the CIR, average power information of the CIR, maximum power information of the CIR, first time peak information of the CIR, NON-RAT method information, NON-RAT method delay information, reference signal received power (RSRP) information based on reference signal measurement, or distribution statistical information of RSRP;
the statistical information corresponding to model output data or other data includes at least one of the following: Non-Light of Sight (NLOS) probability distribution information of propagation paths between a network device and a terminal equipment pair, NLOS probability proportion information, Light of Sight (LOS) probability distribution information, LOS probability proportion information, absolute distribution information of Time of Arrival (TOA) corresponding to propagation paths, relative distribution information of TOA, statistical distribution information of a Reference Signal Time Difference (RSTD) calculated from a reference source, or accuracy information of measured physical quantities of channels.

10. The method according to any of the supplements 2 to 9, wherein the model-related information request and/or the model-related information feedback include(s) at least one of the following: model gradient optimization configuration algorithm information, model test accuracy information, model learning rate information, model convergence time information, or model loss function information.

11. The method according to the supplement 1, wherein the first device is a location server, and the second device is a terminal equipment; the location server transmits an entity-related information request of the location server to the terminal equipment via LPP signaling, and the terminal equipment transmits the entity-related information feedback to the location server via LPP signaling.

12. The method according to the supplement 1, wherein the first device is a location server, and the second device is a base station or a network device; the location server transmits an entity-related information request of the location server to the base station or network device via NRPPa signaling, and the base station or network device transmits entity-related information feedback to the location server via NRPPa signaling.

13. The method according to the supplement 1, wherein the first device is a base station or a network device, and the second device is a terminal equipment; the base station or network device transmits an entity-related information request of the base station or network device to the terminal equipment via RRC signaling or DCI, and the terminal equipment transmits the entity-related information feedback to the base station or network device via RRC signaling.

14. The method according to the supplement 1, wherein the first device is a base station or a network device, and the second device is a location server; the base station or network device transmits an entity-related information request of the base station or network device to the location server via NRPPa signaling, and the location server transmits the entity-related information feedback to the base station or network device via NRPPa signaling.

15. The method according to any of the supplements 11 to 14, wherein the method further includes:
the first device receiving request information for starting training transmitted by the second device.

16. The method according to any of the supplements 11 to 15, wherein the entity-related information request includes at least one of the following: hardware capability information, entity state information, model training software version information, training permission information, training adjustment information, or training rejection information.

17. The method according to any of the supplements 11 to 16, wherein the entity-related information feedback includes at least one of the following: training data collection information, data configuration information, training re-request information, information on a request for transmitting more entity capabilities, information on a request for initiating model selection, or information on a request for initiating fallback.

18. The method according to any of the supplements 1 to 17, wherein the method further includes:
the first device transmitting assistant information for AI/ML model training to the second device; and
the first device receiving feedback information transmitted by the second device.

19. The method according to the supplement 18, wherein the first device is a location server, and the second device is a terminal equipment; the location server transmits the assistant information to the terminal equipment via LPP signaling, and the terminal equipment transmits the feedback information to the location server via LPP signaling.

20. The method according to the supplement 18, wherein the first device is a location server, and the second device is a base station or a network device; the location server transmits the assistant information to the base station via NRPPa signaling, and the base station or network device transmits the feedback information to the location server via NRPPa signaling.

21. The method according to the supplement 18, wherein the first device is a base station or a network device, and the second device is a terminal equipment; the base station or network device transmits the assistant information to the terminal equipment via RRC signaling or DCI, and the terminal equipment transmits the feedback information to the base station or network device via RRC signaling.

22. The method according to the supplement 18, wherein the first device is a base station or network device, and the second device is a location server; the base station or network device transmits the assistant information to the location server via NRPPa signaling, and the location server transmits the feedback information to the base station or network device via NRPPa signaling.

23. The method according to any of the supplements 18 to 22, wherein the assistant information includes at least one of the following: time needed in model training, resource overhead needed in model training, accuracy achievable for model training, time needed in data collection, model training strategy configuration information, training time estimation information, training accuracy estimation information, training data collection time estimation information, or training resource estimation information.

24. The method according to any of the supplements 1 to 23, wherein the method further includes:
the first device receiving request information transmitted by the second device for requesting online data collection; and
the first device performing resource configuration according to the request information.

25. The method according to the supplement 24, wherein the request information further includes at least one of the following: sample data amount expectation information, data dimension information, data collection time length threshold information, data accuracy expectation information, reference signal configuration information of data collection, or reference signal selection information of data collection.

26. The method according to the supplement 24, wherein the method further includes: the first device receiving feedback information transmitted by the second device, wherein the second device generates the feedback information after performing reference signal measurement according to the resource configuration.

27. The method according to the supplement 26, wherein the feedback information includes at least one of the following: data collection termination information, data recollection information, data collection failure information, initiating model selection information, or initiation fallback information.

28. An information interaction method, including:
a second device receiving model-related information request and/or entity-related information request from a first device for optimizing a wireless positioning AI/ML model; and
the second device transmitting to the first device model-related information feedback and/or entity-related information feedback.

29. The method according to the supplement 28, wherein the first device is a location server, and the second device is a terminal equipment; the location server transmits the model-related information request to the terminal equipment via LPP signaling, and the terminal equipment transmits the model-related information feedback to the location server via LPP signaling.

30. The method according to the supplement 28, wherein the first device is a location server, and the second device is a base station or a network device; the location server transmits the model-related information request to the base station via NRPPa signaling, and the base station transmits the model-related information feedback to the location server via NRPPa signaling.

31. The method according to the supplement 28, wherein the first device is a base station or a network device, and the second device is a terminal equipment; the base station or network device transmits the model-related information request to the terminal equipment via RRC signaling, and the terminal equipment transmits the model-related information feedback to the base station or network device via RRC signaling.

32. The method according to any of the supplements 29 to 31, wherein the method further includes:
the second device transmitting request information for starting training to the first device.

33. The method according to any of the supplements 29 to 32, wherein the model-related information request and/or the model-related information feedback include(s): neural network model basic information and/or neural network model-related information.

34. The method according to the supplement 33, wherein the neural network model basic information includes at least one of the following: model size information, model type information, model format information, model layer information, information on a storage space needed by the model, information on the number of neurons per layer, information on an organization mode of neurons, or information on an arrangement mode of neurons;
and the neural network model-related information includes information on a model encoding mode and/or information on a model storage format.

35. The method according to any of the supplements 29 to 34, wherein the model-related information request and/or the model-related information feedback include(s) at least one of the following: model input information, statistical information corresponding to model input data, model output information, or statistical information corresponding to model output data or other data.

36. The method according to the supplement 35, wherein,
the model input information includes at least one of the following: a model input type, time needed in training the model, or an input state;
the statistical information corresponding to the model input data includes at least one of the following: global power distribution information of a channel impulse response (CIR), partial power distribution information of the CIR, global time distribution information of the CIR, partial time distribution information of the CIR, average power information of the CIR, maximum power information of the CIR, first time peak information of the CIR, NON-RAT method information, NON-RAT method delay information, reference signal received power (RSRP) information based on reference signal measurement, or distribution statistical information of RSRP;
the statistical information corresponding to model output data or other data includes at least one of the following: Non-Light of Sight (NLOS) probability distribution information of propagation paths between a network device and a terminal equipment pair, NLOS probability proportion information, Light of Sight (LOS) probability distribution information, LOS probability proportion information, absolute distribution information of Time of Arrival (TOA) corresponding to propagation paths, relative distribution information of TOA, statistical distribution information of a Reference Signal Time Difference (RSTD) calculated from a reference source, or accuracy information of measured physical quantities of channels.

37. The method according to any of the supplements 29 to 36, wherein the model-related information request and/or the model-related information feedback include(s) at least one of the following: model gradient optimization configuration algorithm information, model test accuracy information, model learning rate information, model convergence time information, or model loss function information.

38. The method according to the supplement 28, wherein the first device is a location server, and the second device is a terminal equipment; the location server transmits an entity-related information request of the location server to the terminal equipment via LPP signaling, and the terminal equipment transmits the entity-related information feedback to the location server via LPP signaling.

39. The method according to the supplement 28, wherein the first device is a location server, and the second device is a base station or a network device; the location server transmits an entity-related information request of the location server to the base station or network device via NRPPa signaling, and the base station or network device transmits entity-related information feedback to the location server via NRPPa signaling.

40. The method according to the supplement 28, wherein the first device is a base station or a network device, and the second device is a terminal equipment; the base station or network device transmits an entity-related information request of the base station or network device to the terminal equipment via RRC signaling or DCI, and the terminal equipment transmits the entity-related information feedback to the base station or network device via RRC signaling.

41. The method according to the supplement 28, wherein the first device is a base station or a network device, and the second device is a location server; the base station or network device transmits an entity-related information request of the base station or network device to the location server via NRPPa signaling, and the location server transmits the entity-related information feedback to the base station or network device via NRPPa signaling.

42. The method according to any of the supplements 38 to 41, wherein the method further includes:
the second device transmitting request information for starting training to the first device.

43. The method according to any of the supplements 38 to 42, wherein the entity-related information request includes at least one of the following: hardware capability information, entity state information, model training software version information, training permission information, training adjustment information, or training rejection information.

44. The method according to any of the supplements 38 to 43, wherein the entity-related information feedback includes at least one of the following: training data collection information, data configuration information, training re-request information, information on a request for transmitting more entity capabilities, information on a request for initiating model selection, or information on a request for initiating fallback.

45. The method according to any of the supplements 28 to 44, wherein the method further includes:
the second device receiving assistant information for AI/ML model training from the first device; and
the second device transmitting feedback information to the first device.

46. The method according to the supplement 45, wherein the first device is a location server, and the second device is a terminal equipment; the location server transmits the assistant information to the terminal equipment via LPP signaling, and the terminal equipment transmits the feedback information to the location server via LPP signaling.

47. The method according to the supplement 45, wherein the first device is a location server, and the second device is a base station or a network device; the location server transmits the assistant information to the base station via NRPPa signaling, and the base station or network device transmits the feedback information to the location server via NRPPa signaling.

48. The method according to the supplement 45, wherein the first device is a base station or a network device, and the second device is a terminal equipment; the base station or network device transmits the assistant information to the terminal equipment via RRC signaling or DCI, and the terminal equipment transmits the feedback information to the base station or network device via RRC signaling.

49. The method according to the supplement 45, wherein the first device is a base station or network device, and the second device is a location server; the base station or network device transmits the assistant information to the location server via NRPPa signaling, and the location server transmits the feedback information to the base station or network device via NRPPa signaling.

50. The method according to any of the supplements 45 to 49, wherein the assistant information includes at least one of the following: time needed in model training, resource overhead needed in model training, accuracy achievable for model training, time needed in data collection, model training strategy configuration information, training time estimation information, training accuracy estimation information, training data collection time estimation information, or training resource estimation information.

51. The method according to any of the supplements 28 to 50, wherein the method further includes:
the second device transmitting request information to the first device for requesting online data collection, wherein the first device performs resource configuration according to the request information.

52. The method according to the supplement 51, wherein the request information further includes at least one of the following: sample data amount expectation information, data dimension information, data collection time length threshold information, data accuracy expectation information, reference signal configuration information of data collection, or reference signal selection information of data collection.

53. The method according to the supplement 51, wherein the method further includes:
the second device generating feedback information after performing reference signal measurement according to the resource configuration; and
the second device transmitting the feedback information to the first device.

54. The method according to the supplement 53, wherein the feedback information includes at least one of the following: data collection termination information, data recollection information, data collection failure information, initiating model selection information, or initiation fallback information.

55. An information interaction apparatus including a memory storing a computer program and a processor configured to execute the computer program to implement the information interaction method according to any of the supplements 1 to 27.

56. An information interaction apparatus including a memory storing a computer program and a processor configured to execute the computer program to implement the information interaction method according to any of the supplements 28 to 54.

What is claimed is:

1. An information interaction apparatus, configured in a first device, the information interaction apparatus comprising:
a transmitter configured to transmit to a second device a model-related information request and/or an entity-related information request for optimizing a wireless positioning AI/ML model; and
a receiver configured to receive model-related information feedback and/or entity-related information feedback transmitted by the second device.

2. The apparatus according to claim 1, wherein the first device is a location server, and the second device is a terminal equipment; the location server transmitting the model-related information request to the terminal equipment via LPP signaling, and the terminal equipment transmitting the model-related information feedback to the location server via LPP signaling;
or, the first device is a location server, and the second device is a base station or a network device, the location server transmitting the model-related information request to the base station via NRPPa signaling, and the base station transmitting the model-related information feedback to the location server via NRPPa signaling;
or, the first device is a base station or a network device, and the second device is a terminal equipment, the base station or network device transmitting the model-related information request to the terminal equipment via radio resource control signaling, and the terminal equipment transmitting the model-related information feedback to the base station or network device via radio resource control signaling.

3. The apparatus according to claim 2, wherein the receiver is further configured to receive request information for starting training transmitted by the second device.

4. The apparatus according to claim 2, wherein the model-related information request and/or the model-related information feedback comprise(s): neural network model basic information and/or neural network model-related information.

5. The apparatus according to claim 4, wherein the neural network model basic information comprises at least one of the following: model size information, model type information, model format information, model layer information, information on a storage space needed by the model, information on the number of neurons per layer, information on an organization mode of neurons, or information on an arrangement mode of neurons;
and the neural network model-related information comprises information on a model encoding mode and/or information on a model storage format.

6. The apparatus according to claim 2, wherein the model-related information request and/or the model-related information feedback comprise(s) at least one of the following: model input information, statistical information corresponding to model input data, model output information, or statistical information corresponding to model output data or other data.

7. The apparatus according to claim 6, wherein the model input information comprises at least one of the following: a model input type, time needed in training the model, or an input state;
the statistical information corresponding to model input data comprises at least one of the following: global power distribution information of a channel impulse response, partial power distribution information of a channel impulse response, global time distribution information of a channel impulse response, partial time distribution information of a channel impulse response, average power information of a channel impulse response, maximum power information of a channel impulse response, first time peak information of a channel impulse response, non-radio access technology (NON-RAT) method information, non-radio access technology method delay information, reference signal received power information based on reference signal measurement, or distribution statistical information of reference signal received power;
and the statistical information corresponding to model output data or other data comprises at least one of the following: non-light of sight probability distribution information of propagation paths between a network device and a terminal equipment pair, non-light of sight probability proportion information, light of sight probability distribution information, light of sight probability proportion information, absolute distribution information of arrival times corresponding to propagation paths, relative distribution information of arrival times, statistical distribution information of a reference signal time difference calculated from a reference source, or accuracy information of measured physical quantities of channels.

8. The apparatus according to claim 2, wherein the model-related information request and/or the model-related information feedback comprise(s) at least one of the following: model gradient optimization configuration algorithm information, model test accuracy information, model learning rate information, model convergence time information, or model loss function information.

9. The apparatus according to claim 1, wherein the first device is a location server, and the second device is a terminal equipment, the location server transmitting an entity-related information request of the location server to the terminal equipment via LPP signaling, and the terminal equipment transmitting the entity-related information feedback to the location server via LPP signaling;
or, the first device is a location server, and the second device is a base station or a network device, the location server transmitting an entity-related information request of the location server to the base station or network device via NRPPa signaling, and the base station or network device transmitting entity-related information feedback to the location server via NRPPa signaling;
or, the first device is a base station or a network device, and the second device is a terminal equipment, the base station or network device transmitting an entity-related information request of the base station or network device to the terminal equipment via radio resource control signaling or downlink control information, and the terminal equipment transmitting the entity-related information feedback to the base station or network device via radio resource control signaling;
or, the first device is a base station or a network device, and the second device is a location server, the base station or network device transmitting an entity-related information request of the base station or network device to the location server via NRPPa signaling, and the location server transmitting the entity-related information feedback to the base station or network device via NRPPa signaling.

10. The apparatus according to claim 9, wherein the receiver is further configured to receive request information for starting training transmitted by the second device.

11. The apparatus according to claim 9, wherein the entity-related information request comprises at least one of the following: hardware capability information, entity state information, model training software version information, training permission information, training adjustment information, or training rejection information;
and the entity-related information feedback comprises at least one of the following: training data collection information, data configuration information, training re-request information, information on a request for transmitting more entity capabilities, information on a request for initiating model selection, or information on a request for initiating fallback.

12. The apparatus according to claim 1, wherein the transmitter is further configured to transmit assistant information for AI/ML model training to the second device;
and the receiver is further configured to receive feedback information transmitted by the second device.

13. The apparatus according to claim 12, wherein the first device is a location server, and the second device is a terminal equipment, the location server transmitting the assistant information to the terminal equipment via LPP signaling, and the terminal equipment transmitting the feedback information to the location server via LPP signaling;
or, the first device is a location server, and the second device is a base station or a network device, the location server transmitting the assistant information to the base station via NRPPa signaling, and the base station or network device transmitting the feedback information to the location server via NRPPa signaling;
or, the first device is a base station or a network device, and the second device is a terminal equipment, the base station or network device transmitting the assistant information to the terminal equipment via radio resource control signaling or downlink control information, and the terminal equipment transmitting the feedback information to the base station or network device via radio resource control signaling;
or, the first device is a base station or network device, and the second device is a location server, the base station or network device transmitting the assistant information to the location server via NRPPa signaling, and the location server transmitting the feedback information to the base station or network device via NRPPa signaling.

14. The apparatus according to claim 12, wherein the assistant information comprises at least one of the following: time needed in model training, resource overhead needed in model training, accuracy achievable for model training, time needed in data collection, model training strategy configuration information, training time estimation information, training accuracy estimation information, training data collection time estimation information, or training resource estimation information.

15. The apparatus according to claim 1, wherein the receiver is further configured to receive request information transmitted by the second device for requesting online data collection, and the first device performs resource configuration according to the request information.

16. The apparatus according to claim 15, wherein the request information further comprises at least one of the following: sample data amount expectation information, data dimension information, data collection time length threshold information, data accuracy expectation information, reference signal configuration information of data collection, or reference signal selection information of data collection.

17. The apparatus according to claim 15, wherein the receiver is further configured to receive feedback information transmitted by the second device, wherein the second device generates the feedback information after performing reference signal measurement according to the resource configuration.

18. The apparatus according to claim 17, wherein the feedback information comprises at least one of the following: data collection termination information, data recollection information, data collection failure information, initiating model selection information, or initiation fallback information.

19. An information interaction apparatus, configured in a second device, the information interaction apparatus comprising:
a receiver configured to receive model-related information request and/or entity-related information request from a first device for optimizing a wireless positioning AI/ML model; and
a transmitter configured to transmit to the first device model-related information feedback and/or entity-related information feedback.

20. A communication system, comprising:
a first device configured to transmit a model-related information request and/or an entity-related information request for optimizing a wireless positioning AI/ML model, and receive model-related information feedback and/or entity-related information feedback; and
a second device configured to receive the model-related information request and/or entity-related information request, and transmit model-related information feedback and/or entity-related information feedback.
